(19) United States
(12) Patent Application Publication
(10) Pub. No.: US 2003/0225868 A1
(43) Pub. Date: Dec. 4, 2003

(54) Data acquisition method, electronic apparatus, and storage medium in which data acquisition program is stored

(75) Inventor: Takero Kobayashi, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/424,099

(22) Filed: Apr. 28, 2003

(30) Foreign Application Priority Data
May 31, 2002 (JP) 2002-160688

(51) Int. Cl. G06F 15/177

(52) U.S. Cl. 709/222

(57) ABSTRACT

There is disclosed a protocol agent program including an LDAP protocol driver for acquiring information held by a proxy server which manages a local network disposed to provide a connection service to Internet. Moreover, the protocol agent program registers the information required by each network application program in a request information list, detects the proxy server, for example, at a predetermined interval based on the request information list, and distributes the information acquired from the detected proxy server to each network application program.

### CROSS-REFERENCE TO RELATED APPLICATIONS

This application is based upon and claims the benefit of priority from the prior Japanese Patent Application No. 2002-160688, filed May 31, 2002, the entire contents of which are incorporated herein by reference.

### BACKGROUND OF THE INVENTION

1. Field of the Invention

The present invention relates to a data acquisition method for acquiring various item of setting information for use by network application programs such as a browser from a server computer on a local network which provides, for example, a connection environment to the Internet, an electronic apparatus, and a storage medium in which a data acquisition program is stored. The present invention particularly relates to a data acquisition method which obviates the necessity of preparing a protocol stack for acquiring various item of setting information in each of a plurality of network application programs, electronic apparatus, and storage medium in which the data acquisition program is stored.

2. Description of the Related Art

In recent years, wireless LAN protocols such as IEEE 802.11 have been used to start constructing a wireless network for providing, for example, a connection environment to the Internet everywhere. For example, in a restaurant, this wireless network is laid so that each customer's own computer can be used to access the Internet over lunch. Additional customer service is provided in this manner.

Moreover, in recent years, environment setting information such as a browser has been stored in a proxy server computer disposed on a wireless network to manage access to the Internet, so that the customer's computer acquires the environment setting information. According to this method, when a certain customer uses the Internet, for example, in a shop in Tokyo, a start page (web page first referred to at starting time) of the customer's browser is set to a web page in which community information on Tokyo is introduced. Moreover, when the customer uses the Internet in a shop in Osaka, the start page of the customer's browser can be set to a web page in which community information on Osaka is introduced.

Additionally, as in the environment setting information of the browser, data which is not used by all network application programs and which is used by various network application programs using an arbitrary protocol is acquired from the proxy server computer on the wireless network. In this case, it is general to prepare protocol stacks for performing an acquisition procedure individually for the respective network applications using a communication service provided by the operating system.

However, in this method, for example, even when a plurality of network application programs use the same protocol to acquire the data from the proxy server computer, the same protocol stack is prepared in these network application programs, and resources become redundant. Moreover, even when these programs require the same data, they have to perform the acquisition procedures, and this cannot be said to be a desirable state also from a viewpoint of network traffic.

### BRIEF SUMMARY OF THE INVENTION

One embodiment of the present invention may provide a data acquisition method which obviates the necessity of preparing protocol stacks for acquiring various types of setting information in a plurality of network application programs, an electronic apparatus, and a storage medium in which a data acquisition program is stored.

According to an aspect of the present invention, there is provided a data acquisition method for acquiring setting information of a communication application program using a network, comprising: judging whether or not a device capable of providing the setting information is present; acquiring the setting information from the device when the device is judged to be present; and distributing the acquired setting information to the communication application program.

Moreover, according to another aspect of the present invention, there is provided an electronic apparatus which can execute a communication application program using a network, comprising: a judgment unit configured to judge whether or not there is a device capable of providing information necessary for the communication application program to use the network; an acquisition unit configured to acquire the information from the device when the judgment unit judges the device is present; and a distribution unit configured to distribute the acquired information to the communication application program.

Moreover, according to another aspect of the present invention, there is provided an electronic apparatus system comprising: a first electronic apparatus present on a network; and a second electronic apparatus which can communicate with the first electronic apparatus and which can execute a plurality of communication application programs using the network, wherein the first electronic apparatus comprises: a first storage unit configured to store setting information to be set in an instrument connected to the network, and the second electronic apparatus comprises: a judgment unit configured to judge whether or not the second electronic apparatus can communicate with the first electronic apparatus; a second storage unit configured to store an item of the information to be set in each of the plurality of communication application programs; an acquisition unit configured to acquire the setting information stored in the first storage unit when the judgment unit judges that the second electronic apparatus can communicate with the first electronic apparatus; and a distribution unit configured to distribute the acquired setting information to each of the plurality of communication application programs in accordance with the item stored in the second storage unit.

Additionally, according to another aspect of the, present invention, there is provided a storage medium in which a data acquisition program to be applied to an electronic apparatus to acquire setting information of a plurality of communication application programs using a network is stored, the data acquisition program allowing the electronic apparatus to function as: a judgment unit configured to judge whether or not a device capable of providing the setting information is present; an acquisition unit configured to acquire the setting information from the device when the device is present; and a distribution unit configured to distribute the acquired setting information to the communication application program.

In the present invention, a so-called agent for controlling the protocol, which can be used for a general purpose, is provided, for example, from various network application programs, and this obviates the necessity of preparing the program stacks with respect to a plurality of network application programs.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a connection mode of a network system according to an embodiment of the present invention;

FIG. 2 is a diagram showing a hardware constitution of a personal computer of the embodiment;

FIG. 3 is a diagram showing a software constitution of the personal computer of the embodiment;

FIG. 4 is a diagram showing environment setting information stored in an environment setting information database of the embodiment;

FIG. 5 is a first flowchart showing an operation procedure of a protocol agent program of the embodiment; and

FIG. 6 is a second flowchart showing the operation procedure of the protocol agent program of the embodiment.

### DETAILED DESCRIPTION OF THE INVENTION

The embodiments of the present invention will be described below with reference to the drawings.

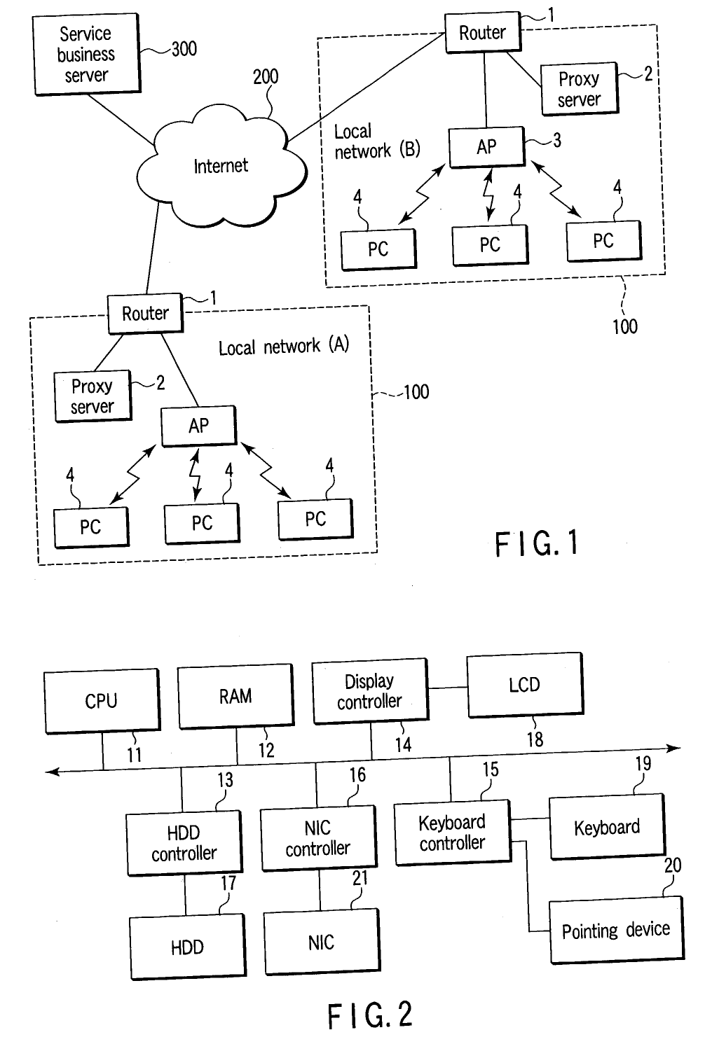

FIG. 1 is a diagram showing a connection mode of a network system according to the embodiment of the present invention.

Local networks 100 are network environments including wireless LANs scattered in locations to provide connection services to the Internet 200. Each network is constituted of a router 1, server 2, and access point (hereinafter referred to as AP) 3. Moreover, personal computers 4 of customers who use this connection service are connected to a desired service business server 300 via the Internet 200.

The router 1 is a relay device for connecting the local network 100 to the Internet 200. The router 1 has the function of sending data on the local network 100 and which is addressed to the outside to the Internet 200, and taking in data on the Internet 200 and which is addressed to the inside of the local network 100.

The server 2 is a computer disposed to manage various item of information for connecting the personal computer 4 to the Internet 200 via the local network 100. For example, an IP address which is an address on the Internet 200 is appropriately leased to the personal computer 4 of the customer from this server 2. Moreover, this server 2 also has, for example, a security function of preventing an illegal access from the Internet 200 side, and a cache function of a proxy server which prevents redundant access to the Internet 200 concerning the same data. Furthermore, the server 2 also holds environment setting information for use in a network application program such as a browser which operates on the customer's personal computer 4. Additionally, the network system of this embodiment is characterized in a supporting mechanism provided so that the personal computer 4 can efficiently acquire, for example, the environment setting information of the network application program held by the server 2. This respect will be described later in detail.

The AP 3 is a relay device which has a wireless communication function which can connect the local network 100 to the customer's personal computer 4 via wireless communication and which forms a wireless communication area in a predetermined range. Moreover, the AP 3 performs the communication with the personal computer 4 in the formed area using, for example, radio waves in a 2.4 GHz band.

FIG. 2 is a diagram showing a hardware constitution of the personal computer 4.

This personal computer 4 is, for example, a notebook-type computer. As shown in FIG. 2, a CPU 11, RAM 12, hard disk drive (hereinafter referred to as an-HDD) controller 13, display controller 14, keyboard controller 15, and network interface card (hereinafter referred to as an NIC) controller 16 are connected to a system bus.

The CPU 11 manages the control of the whole personal computer 4, and operates in accordance with the program stored in the RAM 12. The RAM 12 is a memory device which is the main storage of the personal computer 4, and stores the program in which the operation procedure of the CPU 11 is described and data input/output with respect to the program. Moreover, the HDD controller 13 drives/controls an HDD 17 which is external storage of the personal computer 4. In the HDD 17 which is an auxiliary device of the RAM 12, a large amount of program and data are stored.

The display controller 14 manages output of a user interface in the personal computer 4, and controls display of image data prepared by the CPU 11 on an LCD 18. On the other hand, the keyboard controller 15 manages input of the user interface in the personal computer 4, prepares data of an operation input via a keyboard 19 or pointing device 20, and transmits the data to the CPU 11.

Moreover, the NIC controller 16 drives/controls a network interface card (NIC) 21 which receives/ transmits the data with respect to the AP 3 by wireless.

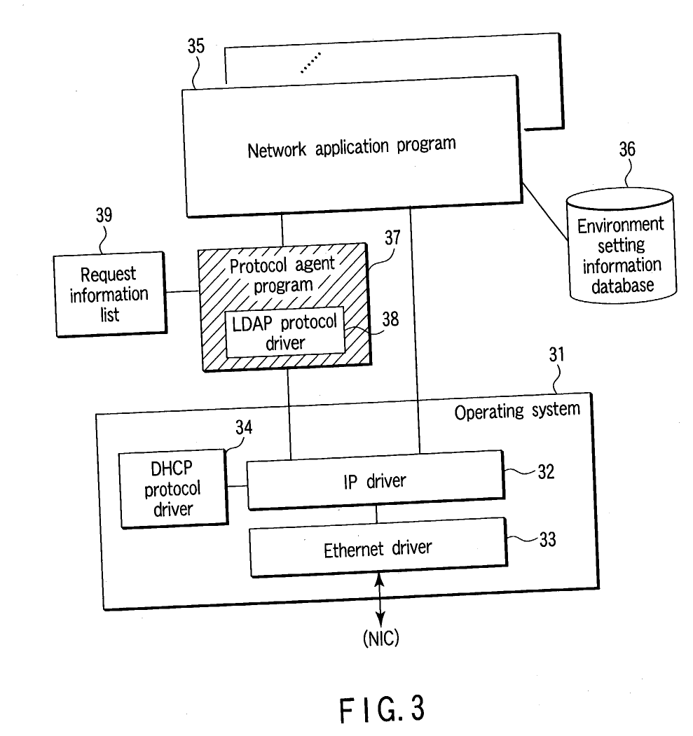

FIG. 3 is a diagram showing the software constitution of the personal computer 4.

An operating system 31 is a basic program which generally manages the resource of the personal computer 4. All of various application programs including a network application program 35 such as the browser operate under the control of the operating system 31. Moreover, the operating system 31, which is a network service mechanism, includes an IP driver 32, Ethernet driver 33, and dynamic host configuration protocol (DHCP) protocol driver 34.

The IP driver 32 controls data transfer of an upper layer in the OSI. On the other hand, the Ethernet driver 33 controls the data transfer of a lower layer in the OSI. Moreover, the DHCP protocol driver 34 is a protocol stack for acquiring various item of information including the IP address from the server 2. It is to be noted that the information acquired by the DHCP protocol driver 34 is limited to basic information for connecting the personal computer 4 to the local network 100, and does not include any setting information used in the network application program 35 such as the browser.

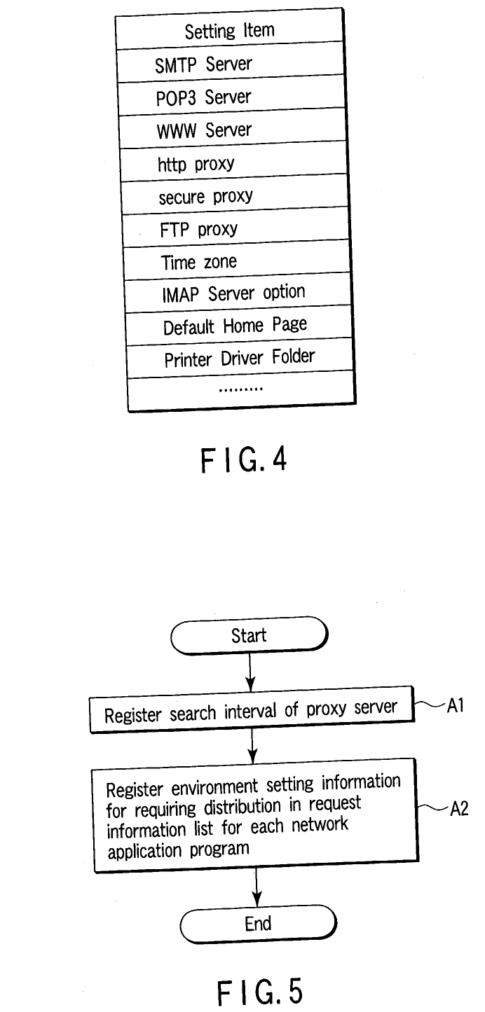

Examples of the network application program 35 include: a browser for browsing web pages published by the arbitrary service business server 300; a mailer for transmitting/receiving mail with respect to the service business server 300 which is a mail server; and the like. The program operates under the control of the operating system 31. Moreover, each network application program 35 uses the environment setting information stored in an environment setting information database 36 to set its own operation environment. FIG. 4 is a diagram showing the environment setting information stored in this environment setting information database 36. Here, it is assumed that parameters indicating a start page of the browser such as a default web page are stored.

Here, it is assumed that this parameter is acquired from the server 2 of the connected local network 100. That is, the information of the start page of the browser is automatically acquired in response to the connected local network 100.

In this case, in the related art, it has heretofore been general to dispose the protocol stack for acquiring the parameter in each browser using the parameter, that is, each network application program 35, and to acquire the information by the protocol for each application.

However, in this case, as described above, it is supposed that the same protocol stack is present in the plurality of network application programs 35, and the resource of the server 2 becomes redundant. Moreover, even when these programs require the same data, the protocol of each application program has to perform the acquisition procedure, and this cannot be said to be a desirable state also from the viewpoint of network traffic.

To solve the problem, in this embodiment, the network application program 35 provides a protocol agent program 37 for controlling the protocol, which can be used by a standard application protocol interface (API), and this obviates the necessity of preparing the program stack for each of the plurality of network application programs 35.

This protocol agent program 37 includes a lightweight directory access protocol (LDAP) protocol driver 38 for acquiring the environment setting information held by the server 2. The environment setting information acquired by the LDAP protocol driver 38 is distributed to each network application program 35 based on registered content managed by a request information list 39. This request information list 39 indicates the parameter requested to be distributed in the environment setting information, for example, shown in FIG. 4, and holds content requested from the network application program 35. Moreover, in the request information list 39, the environment setting information for determining the operation of the protocol agent program 37 itself is also held, such as an interval of repetition of acquisition of the environment setting information from the server 2.

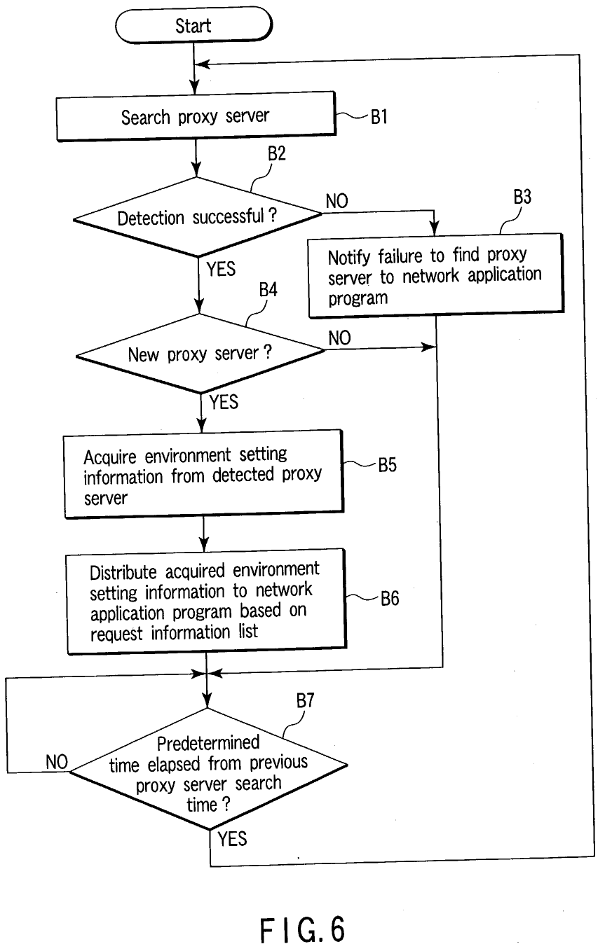

The operation procedure of the protocol agent program 37 will be described hereinafter with reference to FIGS. 5 and 6.

First, the protocol agent program 37 registers a search interval of the server 2 input by a user of the personal computer 4 by the user interface provided by the program in the request information list 39 (step A1 of FIG. 5). Moreover, the protocol agent program 37 also registers the environment setting information requested to be distributed by each network application program 35 in the request information list 39 via the API provided by the protocol agent program (step A2 of FIG. 5).

Next, the protocol agent program 37 sends out a detection packet for detecting the server 2 (step B1 of FIG. 6). If detection of the server 2 fails (NO in step B2 of FIG. 6), the protocol agent program 37 notifies each network application program 35 of the failure (step B3 of FIG. 6). A countermeasure on receiving this notice is arbitrarily determined by each network application program 35. Typically, it is supposed that the parameter updated at connection time to the certain local network 100 be returned to its original state.

On the other hand, when the detection of the server 2 is successful (YES in step B2 of FIG. 6), the protocol agent program 37 judges whether the server is the same as the previously detected server 2 (step B4 of FIG. 6). If the server is different (NO in step B4 of FIG. 6), the protocol agent program 37 uses the LDAP protocol driver 38 to acquire various item of environment setting information from the newly detected server 2 (step B5 of FIG. 6). Subsequently, the protocol agent program 37 distributes the acquired various item of environment setting information to the network application program 35 based on the request information list 39 (step B6 of FIG. 6).

Thereafter, the protocol agent program 37 waits for elapse of a search time interval registered beforehand (step B7 of FIG. 6). When the search time interval elapses, the process is repeated from the step B1 of FIG. 6.

As described above, in this embodiment, the protocol agent program 37 acquires various item of environment setting information from the server 2 and distributes the information for each network application program 35. The protocol agent program 37 is provided including the standard API so that each network application program 35 can use the protocol agent program for general purposes. This obviates the necessity of preparing the protocol stacks for acquiring various item of setting information individually for the network application programs 35.

It is to be noted that the example for realizing the method of searching for the server 2 with the pre-registered time interval to acquire the environment setting information and consequently automatically updating the environment setting of the network application program 35 has been described herein. However, the present invention is not limited to this example. For example, the present invention is also useful for acquiring the environment setting information from the server 2 only when an instructing operation for updating the information is explicitly performed.

Moreover, when a server 2 different from the previous server is detected, various item of setting information is acquired and distributed. Instead, the parameter which exists in the various item of setting information acquired from the detected server 2 (regardless of the difference from the previous server) and which is different from the parameter acquired before may also be distributed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data acquisition method for acquiring setting information of a communication application program using a network, comprising:
judging whether or not a device capable of providing the setting information is present;
acquiring the setting information from the device when the device is judged to be present; and
distributing the acquired setting information to the communication application program.

2. The data acquisition method according to claim 1, further comprising: judging whether or not the device is present every predetermined time interval.

3. The data acquisition method according to claim 1, further comprising:
storing an item of the setting information to be set in the communication application program; and
distributing the acquired setting information to the communication application program based on the stored item of the setting information.

4. The data acquisition method according to claim 1, further comprising: notifying the communication application program of the absence of the device when the device is not present.

5. The data acquisition method according to claim 1, wherein the device can connect a local area network to a wide area network, and stores the setting information of the wide area network, which is required in connecting an instrument connected to the local area network to the wide area network.

6. A data acquisition method for acquiring setting information of a communication application program using a network, comprising:
judging whether or not a device capable of providing the setting information is present every predetermined time interval;
acquiring the setting information from the device when the device is present; and
distributing the acquired setting information to the communication application program when the acquired setting information is different from the previously acquired setting information.

7. The data acquisition method according to claim 6, further comprising:
storing an item of the setting information to be set in the communication application program; and
distributing the acquired setting information to the communication application program based on the stored item of the setting information.

8. The data acquisition method according to claim 6, further comprising: notifying the communication application program of the absence of the device when the device is not present.

9. The data acquisition method according to claim 6, wherein the device can connect a local area network to a wide area network, and stores the setting information of the wide area network, which is required in connecting an instrument connected to the local area network to the wide area network.

10. An electronic apparatus which can execute a communication application program using a network, comprising:
a judgment unit configured to judge whether or not there is a device capable of providing information necessary for the communication application program to use the network;
an acquisition unit configured to acquire the information from the device when the judgment unit judges the device is present; and
a distribution unit configured to distribute the acquired information to the communication application program.

11. An electronic apparatus according to claim 10, further comprising a storage unit configured to store an item of the information to be set in the communication application programs; and
wherein the distribution unit configured to distribute the acquired information to the plurality of communication application programs in accordance with the item stored in the storage unit.

12. An electronic apparatus system comprising:
a first electronic apparatus present on a network; and
a second electronic apparatus which can communicate with the first electronic apparatus and which can execute a plurality of communication application programs using the network,
wherein the first electronic apparatus comprises:
a first storage unit configured to store setting information to be set in an instrument connected to the network, and
the second electronic apparatus comprises:
a judgment unit configured to judge whether or not the second electronic apparatus can communicate with the first electronic apparatus;
a second storage unit configured to store an item of the information to be set in each of the plurality of communication application programs;
an acquisition unit configured to acquire the setting information stored in the first storage unit when the judgment unit judges that the second electronic apparatus can communicate with the first electronic apparatus; and
a distribution unit configured to distribute the acquired setting information to each of the plurality of communication application programs in accordance with the item stored in the second storage unit.

13. The electronic apparatus system according to claim 12, wherein the network is a local area network, the first electronic apparatus is connected to the local area network and a wide area network, and the setting information can allow the plurality of communication application programs to use the wide area network in connecting the second electronic apparatus connected to the local area network to the wide area network.

14. A storage medium in which a data acquisition program to be applied to an electronic apparatus to acquire setting information of a plurality of communication application programs using a network is stored, the data acquisition program allowing the electronic apparatus to function as:
a judgment unit configured to judge whether or not a device capable of providing the setting information is present;
an acquisition unit configured to acquire the setting information from the device when the device is present; and
a distribution unit configured to distribute the acquired setting information to the communication application program.

15. The storage medium according to claim 14, in which the data acquisition program is stored to allow the electronic apparatus to further function as a required data registration unit configured to register a type of the setting information necessary for setting communication of the communication application program for each of the plurality of communication application programs.
